(19) United States
(12) Patent Application Publication
(10) Pub. No.: US 2018/0098019 A1
(43) Pub. Date: Apr. 5, 2018

(54) SIGNAL PROCESSING DEVICE AND SIGNAL PROCESSING METHOD OF TELEVISION RECEIVING END

(71) Applicant: MStar Semiconductor, Inc., Hsinchu Hsien (TW)

(72) Inventors: Kun-Yu Wang, Zhubei City (TW); Fong Shih Wei, Zhubei City (TW); Yi-Ying Liao, Zhubei City (TW); Tai-Lai Tung, Zhubei City (TW)

(21) Appl. No.: 15/452,919

(22) Filed: Mar. 8, 2017

(30) Foreign Application Priority Data
Oct. 5, 2016 (TW) 105132156

(51) Int. Cl. H04N 5/50; H04N 5/04; H04N 5/14

(52) U.S. Cl. CPC H04N 5/50; H04N 5/14; H04N 5/04

(57) ABSTRACT

A signal processing device of a television receiving end is provided. The television receiving end includes a tuner, which receives a television signal including a preamble signal. The signal processing device includes: an analog-to-digital converter, converting the television signal from an analog format to a digital format; an FFT circuit, transforming the television signal in the digital format to a frequency domain; a preamble data detecting circuit, detecting the preamble signal in the frequency-domain television signal to generate a preamble data detection result; a frequency notch detecting circuit, detecting a frequency notch of the preamble signal in the frequency-domain television signal according to the preamble data detection result to generate a frequency notch detection result; and a decoder, decoding the frequency-domain television signal to generate decoded data. The frequency notch detection result is for the tuner to accordingly determine whether to change the receiving frequency band.

This application claims the benefit of Taiwan application Serial No. 105132156, filed Oct. 5, 2016, the subject matter of which is incorporated herein by reference.

### BACKGROUND OF THE INVENTION

### Field of the Invention

The invention relates in general to a television, and more particularly to a signal processing device and signal processing method of a television receiving end.

### Description of the Related Art

In an orthogonal frequency-division multiplexing (OFDM) communication system, certain frequency bands are reserved and not used by the communication system to prevent incurring interference with other communication systems. An example of a Digital Video Broadcasting-Cable 2 (DVB-C2) television system is given below. FIG. 1 shows the architecture of an OFDM data frame. In the time domain, one OFDM data frame is formed by a plurality of OFDM symbols, which may be divided into preamble data (denoted as PD) and body data (denoted as BD). The preamble data includes Lₚ*n OFDM symbols (for DVB-C2, 1≦Lₚ≦8, and n is determined by a maximum effective bandwidth of DVB-C2 signals). These OFDM symbols are also referred to as preamble symbols. Each of the preamble symbols includes 3408 subcarriers, and all of the preamble symbols have substantially the same contents as a preamble symbol (0, 0). The body data includes L_{Data}*K OFDM symbols (for DVB-C2, L_{Data}=448, and k is determined by a maximum effective bandwidth of DVB-C2 signals). These OFDM symbols are also referred to as data symbols. As shown, one frequency notch exists between a data symbol (rₚ, 1) and a data symbol (rₚ, 2) of the OFDM data frame (0≦rₚ≦L_{Data}−1). This frequency notch is the foregoing intentionally preserved frequency band that is not used for transmitting any data. Position information of the frequency notch is recorded in each preamble symbol.

Because a receiving end of a communication system cannot learn in advance the position of a frequency notch in received data, the received data can only be directly parsed instead. For example, subsequent demodulation and decoding operations are directly performed on the received data. When the preamble symbol cannot be obtained after parsing, the frequency band current received is determined as including the frequency notch, and so a frontend tuner is informed to switch to receive data of other frequency bands. The above process is iterated until the preamble symbol is obtained after parsing, and the correct position of the frequency notch is then obtained from the preamble symbol. However, the above method is too time-consuming, which leads to degraded circuit performance. Therefore, there is a need for a more stable and faster method for detecting the frequency notch.

### SUMMARY OF THE INVENTION

The invention is directed to a signal processing device and signal processing method of a television receiving end to accelerate a signal processing speed of the television receiving end.

The present invention discloses a signal processing device for a television receiving end. The television receiving end includes a tuner that receives a television signal, which includes preamble data. The signal processing device includes: an analog-to-digital converter (ADC), converting the television signal from an analog format to a digital format; a fast Fourier transform (FFT) circuit, transforming the television signal in the digital format to a frequency-domain television signal; a preamble data detecting circuit, detecting the preamble data in the frequency-domain television signal to generate a preamble data detection result; a frequency notch detecting circuit, detecting a frequency notch of the preamble data in the frequency-domain television signal according to the preamble data detection result to generate a frequency notch detection result; and a decoder, decoding the frequency-domain television signal to generate decoded data. The frequency notch detection result is for the tuner to accordingly determine whether to change a receiving frequency band.

The present invention further discloses a signal processing method for a television receiving end. The television receiving end includes a tuner that receives a television signal, which includes preamble data. The signal processing method includes: converting the television signal from an analog format to a digital format; transforming the television signal in the digital format to a frequency-domain television signal; detecting the preamble data in the frequency-domain television signal to generate a preamble data detection result; detecting a frequency notch of the preamble data in the frequency-domain television signal according to the preamble data detection result to generate a frequency notch detection result; and decoding the frequency-domain television signal to generate decoded data. The frequency notch detection result is for the tuner to accordingly determine whether to change a receiving frequency band.

The signal processing device and signal processing method for a television receiving end of the present invention are capable of promptly determining whether a currently processed frequency band includes a frequency notch, and immediately switch the frequency band once discovering that the preamble symbol cannot be parsed to reduce the time needed for the television receiving end to reach a stable state. Compared to the prior art, the present invention is capable of more promptly switching to a correct frequency band to allow the system to more quickly become stable.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of the architecture of a DVB-C2 OFDM data frame;

FIG. 2 is a block diagram of a signal processing device for a television receiving end according to an embodiment of the present invention;

FIG. 3 is a flowchart of a signal processing method for a television receiving end according to an embodiment of the present invention;

FIG. 4 to FIG. 6 are schematic diagrams of preamble symbols including a frequency notch;

FIG. 7 is a block diagram of a frequency notch detecting circuit 260 according to an embodiment of the present invention;

FIG. 8 is a flowchart of step S340 in FIG. 3 according to an embodiment of the present invention;

FIG. 9 is a block diagram of a detector 740 according to an embodiment of the present invention; and

FIG. 10 is a flowchart of a detecting method of the detector 740 according to an embodiment of the present invention.

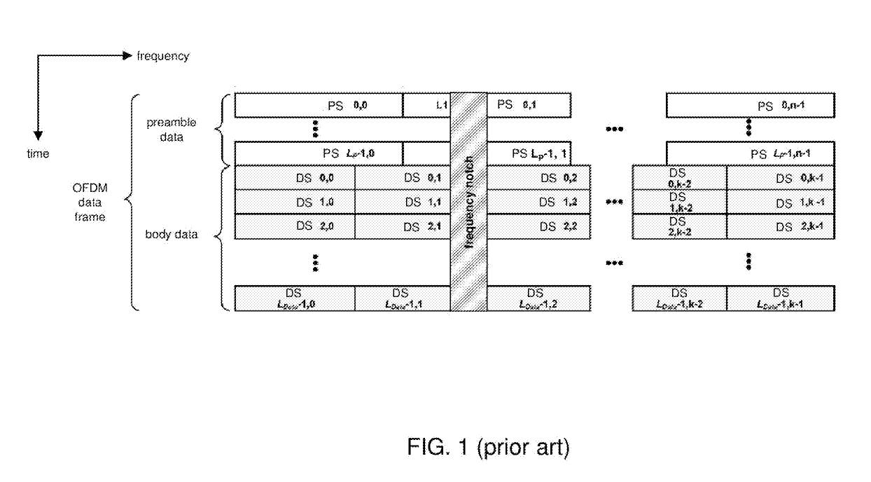

### DETAILED DESCRIPTION OF THE INVENTION

The disclosure of the application includes a signal processing device and signal processing method of a television receiving end. The device and method are applicable to a receiving end of a Digital Video Broadcasting (DVB) television system. In possible implementation, one person skilled in the art may choose equivalent elements or steps to realize the present invention; that is, the implementation of the present invention is not limited to the non-limiting embodiments below.

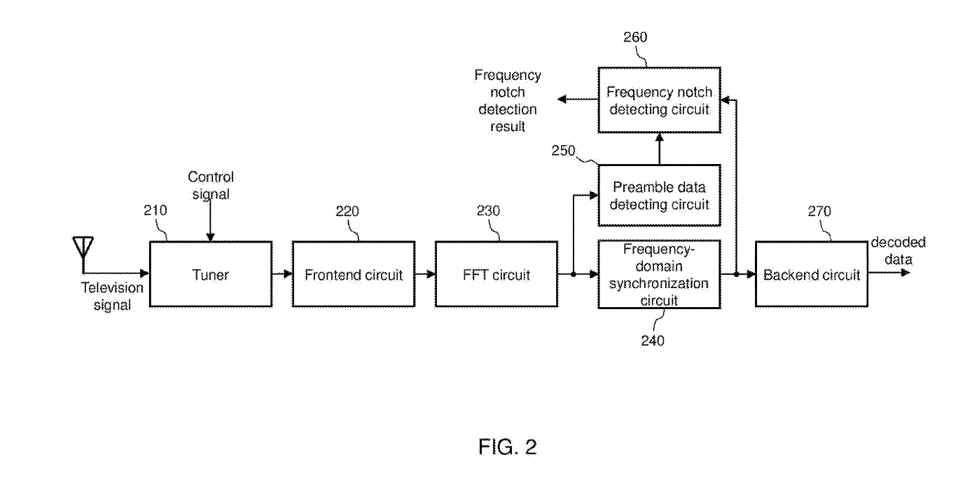

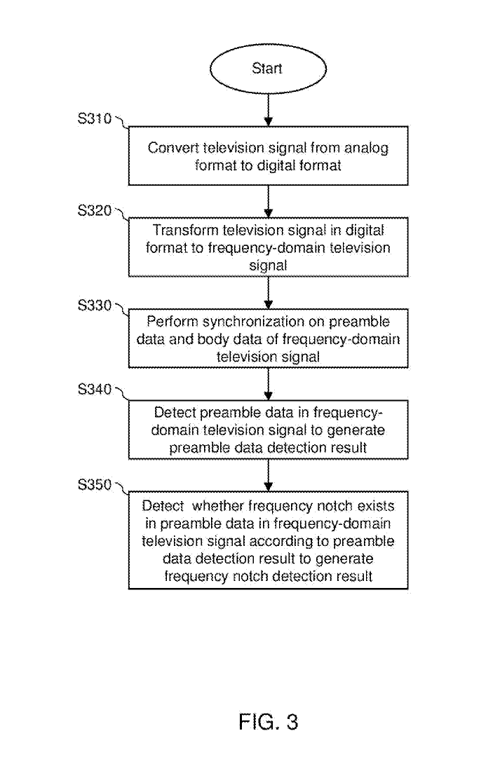

FIG. 2 shows a block diagram of a signal processing device of a television receiving end according to an embodiment of the present invention. FIG. 3 shows a flowchart of a signal processing method of a television receiving end according to an embodiment of the present invention. The signal processing device includes a tuner 210, a frontend circuit 220, a fast Fourier transform (FFT) circuit 230, a frequency-domain synchronization circuit 240, a preamble data detecting circuit 250, a frequency notch detecting circuit 260 and a backend circuit 270. The tuner 210 receives a television signal of a predetermined frequency band via an antenna according to a control signal. The television signal includes preamble data and body data. The frontend circuit 220 performs processes including amplification, down-conversion and analog-to-digital conversion (performed by an analog-to-digital converter (ADC), not shown) to generate the television signal in a digital format (step S310). The FFT circuit 230 transforms the television signal in the digital format to a frequency-domain television signal (step S320). The frequency-domain synchronization circuit 240 performs synchronization on the preamble data and body data of the frequency-domain television signal (step S330), e.g., removing an integer carrier frequency offset (ICFO). The preamble data detecting circuit 250 detects the preamble data in the frequency-domain television signal to generate a preamble data detection result (step S340). More specifically, because the preamble data includes multiple pilot signals and the body data does not, the preamble data and the body data may be distinguished through a correlation calculation. The frequency notch detecting circuit 260 determines whether the preamble data in the frequency-domain television signal includes a frequency notch to generate a frequency notch detection result (step S350). More specifically, the frequency notch detecting circuit 260 is able to learn whether the current data is the preamble data or the body data according to the preamble data detection result, and performs frequency notch detection on only the preamble data, thus preventing misjudgment caused by data symbols of the body data that do not carry any data. When the frequency notch detection result indicates that the frequency band currently received includes a frequency notch, a control circuit (not shown) of the signal processing device immediately issues a control signal to control the tuner 210 to switch the frequency band. The backend circuit 270 may include a demodulation circuit and a decoder that perform operations such as demodulation and decoding on the digital television signal to obtain decoded data. More specifically, the backend circuit 270 operates only after the frequency notch detection result indicates that the currently received frequency band does not include any frequency notch. The control circuit may be implemented by a logic circuit or software or/and hardware. According to the present invention, without involving operations of the backend circuit, whether the currently received frequency band includes a frequency notch can be directly detected by the preamble data detecting circuit 250 and the frequency notch detecting circuit 260, and the frequency band of the tuner may be directly switched when the currently received frequency band includes a frequency notch. Such approach, as opposed to known technologies, determines whether a frequency notch is included according to whether preamble data can be obtained from parsing and is thus more efficient. Further, the backend circuit 270 may operate only after the frequency notch detection result indicates that the currently received frequency band does not include a frequency notch, hence saving power. In the embodiment in FIG. 2, the frequency notch detecting circuit 260 detects a television signal that has been synchronized by the frequency domain synchronization circuit 240. In practice, as the frequency notch detecting circuit 260 is not affected by whether the television signal has been synchronized, the frequency-domain synchronization circuit 240 may be controlled by the control circuit not to perform signal synchronization before the tuner 210 reaches a stable state (i.e., the tuner 210 is still in an adjustment phase), so as to further save time and power consumption. When the tuner 210 reaches a stable state (i.e., the tuner 210 has selected a receiving frequency band), the control circuit then controls the frequency-domain synchronization circuit 240 to start performing synchronization, and controls the preamble data detecting circuit 250 and the frequency notch detecting circuit 260 to be temporarily disabled to save power consumption. In another embodiment, the frequency notch detecting circuit 260 may also directly detect the frequency-domain television signal outputted from the FFT circuit 230.

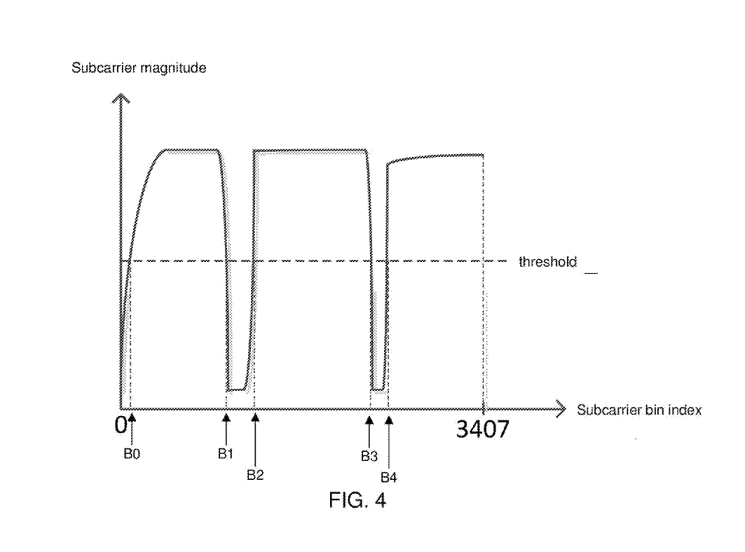

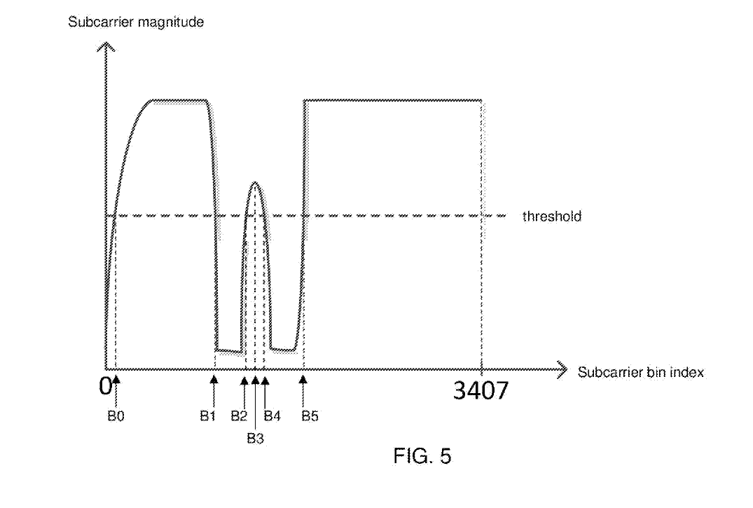

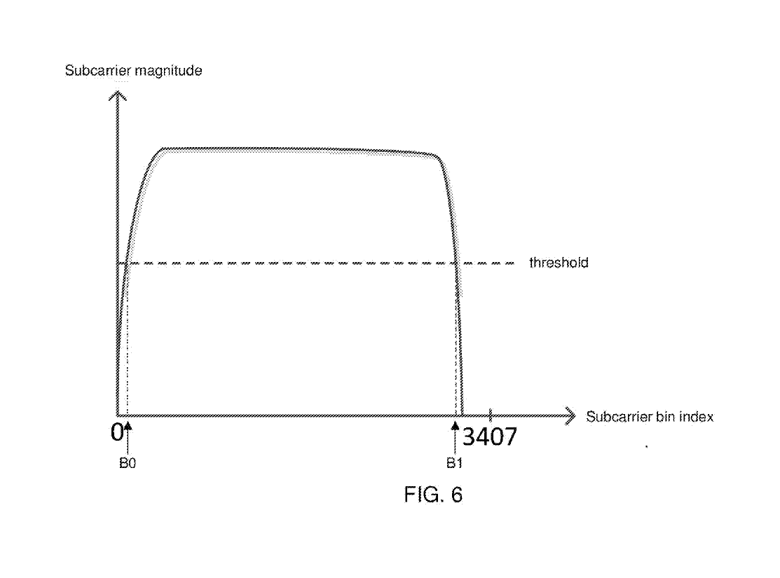

FIG. 4 to FIG. 6 are schematic diagrams of preamble symbols including a frequency notch. In the drawings, the horizontal axis represents a bin index of subcarriers (to be referred to as a subcarrier bin index), and the vertical axis represents a magnitude of subcarriers (to be referred to as a subcarrier magnitude). For example, assuming that the value of each subcarrier is represented by an in-phase I and a quadrature-phase Q, the subcarrier magnitude is \sqrt{I²+Q²}. In FIG. 4 to FIG. 6, a wired DVB television system is taken as an example, and so one preamble symbol includes 3408 subcarriers. As shown in FIG. 4, B0 represents a subcarrier bin index of a subcarrier magnitude that exceeds a threshold for the first time. One frequency notch is included between subcarrier bin indices B1 and B2 and another frequency notch is included between subcarrier bin indices B3 and B4. A frequency notch having a width (B2−B1+1 or B4−B3+1) smaller than a first predetermined value (e.g., 48 subcarriers) is defined as a narrowband frequency notch, and a frequency notch having a width greater than or equal to the first predetermined value is defined as a broadband frequency notch. When a preamble symbol includes two or more narrowband frequency notches (as shown in FIG. 4), the television receiving end is incapable of obtaining the preamble symbol from parsing, and the control circuit at this point controls the tuner 210 to switch the receiving frequency band. A relatively broader frequency notch is included between the subcarrier indices B1 and B5 in FIG. 5, which may be caused by a noise signal (at the subcarrier B3) in a broadband frequency notch, or by two narrowband frequency notches located too closely. However, given that the preamble symbol includes one broadband frequency notch or the equivalent width of the frequency notch is greater than or equal to the width of a broadband frequency notch, the television receiving end is incapable of obtaining the preamble signal from parsing, and the control circuit at this point controls the tuner 210 to switch the receiving frequency band. In FIG. 6, the subcarrier magnitude of the preamble symbol is smaller than or equal to the threshold (located at the subcarrier bin index B1) before the subcarrier bin index reaches the maximum value 3407, which means that an end of the preamble symbol may contain a frequency notch. Thus, when the effective width (may be calculated according to the subcarrier indices B0 and B1) of a preamble symbol is smaller than a second predetermined value (e.g., 3408-48 subcarriers), the preamble symbol is determined as a preamble symbol that cannot be obtained from parsing, and the control circuit at this point controls the tuner 210 to switch the frequency band. FIG. 4 to FIG. 6 show three examples containing frequency notches, due to which the preamble symbol cannot be obtained from parsing. It is understood that the signal processing device and signal processing method of the present invention are not limited to detecting these three exemplary patterns.

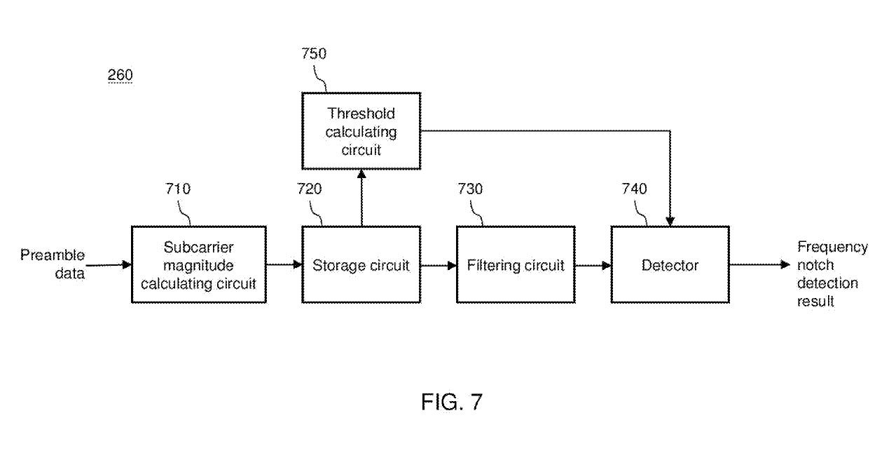

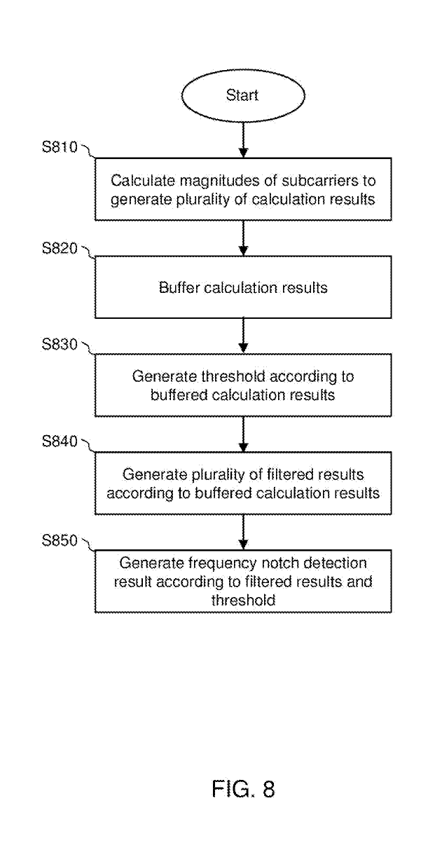

FIG. 7 shows a block diagram of the frequency notch detecting circuit 260 according to an embodiment of the present invention. FIG. 8 shows a flowchart of step S340 in FIG. 3 according to an embodiment of the present invention. The frequency notch detecting circuit 260 includes a subcarrier magnitude calculating circuit 710, a storage circuit 720 (e.g. a register), a filtering circuit 730, a detector 740 and a threshold calculating circuit 750. The subcarrier magnitude calculating circuit 710 calculates subcarrier magnitude of each of the subcarriers in the preamble data to obtain a plurality of calculation results (step S810). The subcarrier magnitude calculating circuit 710 buffers these calculation results in the storage circuit 720 (step S820). The threshold calculating circuit 750 generates a threshold according to these calculation results (step S830). More specifically, the threshold calculating circuit 750 multiples a maximum of the calculation results by a predetermined value to obtain the threshold. In one embodiment, to prevent an excessively large threshold from causing misjudging a frequency notch, the subcarrier magnitude calculating circuit 710 compares the calculation results with an upper limit, and stores the upper limit but not the calculation results to the storage circuit 720 when the calculation results exceed the upper limit. The filtering circuit 730 generates a plurality of filtered results according to the buffered calculation results (step S840). More specifically, to prevent a large variance in the subcarrier magnitude from causing misjudgment, these calculation results are first filtered to obtain filtered results having a smaller variance. In one embodiment, the filtering circuit 730 is implemented by a moving average calculating circuit (i.e., step S840 performs filtering according to moving average calculation). The detector 740 then generates the frequency notch detection results according to the filtered results and the threshold (step S850). More specifically, each time the filtering circuit 730 outputs one filtered result, the detector 740 compares the filtered result with the threshold to identify a cutoff point (i.e., the subcarrier indices B0, B1 . . . in FIG. 4 to FIG. 6), and determines whether the frequency notch exists according to the cutoff points, i.e., determining whether the preamble data can be obtained from parsing. Due to a buffering unit included in the moving average calculating circuit (assuming the buffering unit stores L calculation results, where L is a positive integer), the output of the filtering circuit 730 contains a delay of L subcarriers. Considering the delay, the detector 740 may identify the subcarrier bin index corresponding to edges of the frequency notch and edges of the preamble symbol according to the cutoff points. Three exemplary patterns in FIG. 4 to FIG. 6 are used to describe the mechanism of the detector 740 for determining the cutoff points and the frequency notch.

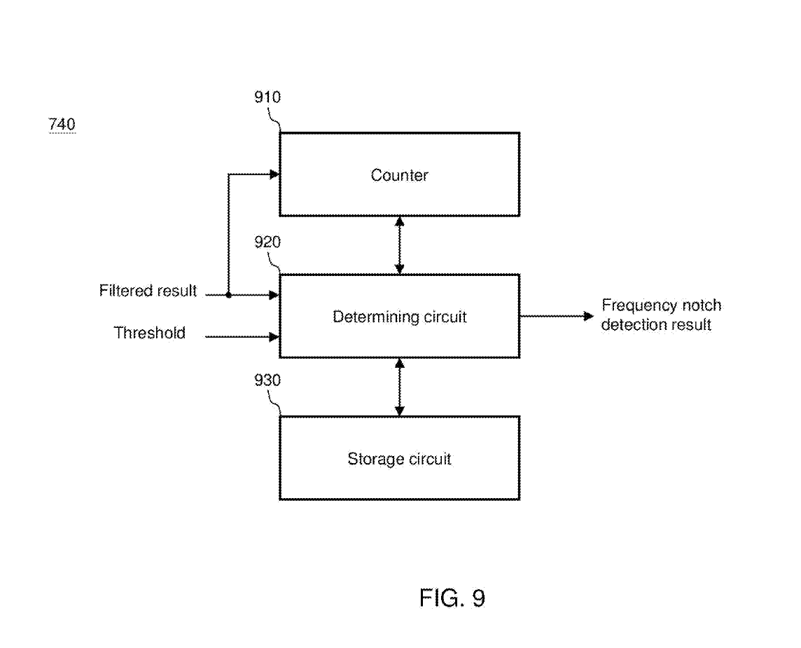

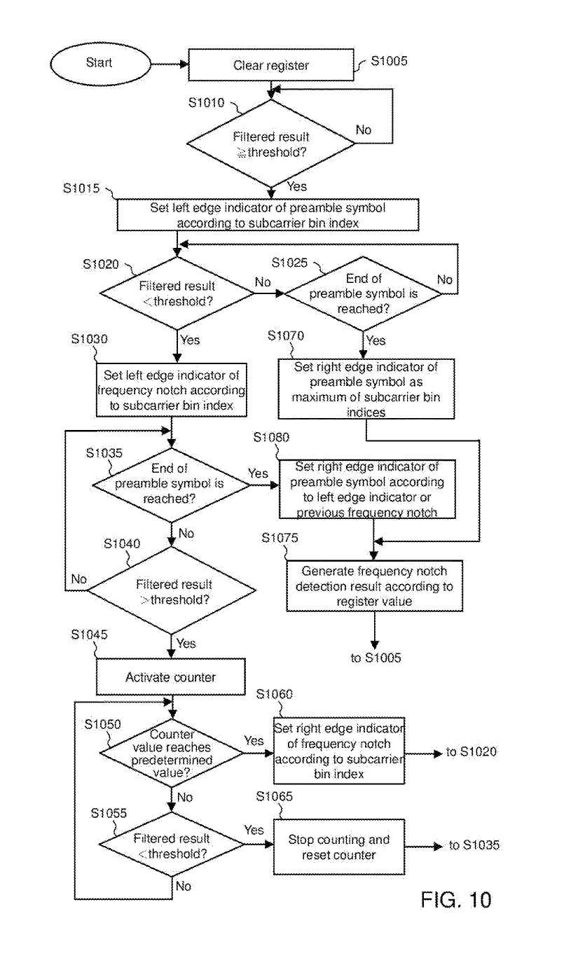

In one embodiment, the detector 740 detects (1) the width of the preamble symbol, (2) the width of the frequency notch and (3) the number of frequency notches according to the filtered results, and generates the frequency notch detection result according to the three types of information. FIG. 9 shows a block diagram of the detector 740 according to an embodiment. The detector 740 includes a counter 910, a determining circuit 920 and a storage circuit 930 (e.g. a register). FIG. 10 shows a flowchart of the detecting method of the detector 740 according to an embodiment. Initially, the determining circuit 920 clears a register value in the storage circuit 930 (step S1005). The determining circuit 920 continuously compares the filtered result with the threshold (step S1010). When the filtered result is greater than or equal to the threshold (at this point, the filtered result in one preamble symbol is greater than or equal to the threshold for the first time), the determining circuit 920 sets a left edge indicator of the preamble symbol according to the subcarrier bin index that is corresponding to the filtered result (step S1015), and stores the left edge indicator of the preamble symbol to the storage circuit 930. This left edge indicator of the preamble symbol is to be later used for determining the width of the preamble symbol. Next, the determining circuit 920 determines whether the filtered result is smaller than the threshold (step S1020). When the determination result is negative, it is determined whether the filtered result has reached the end of the preamble symbol (step S1025), e.g., for a wired DVB television system, determining whether the subcarrier bin index has reached 3407. The determining circuit 920 continues performing steps S1020 and S1025. For the situations in FIG. 4 to FIG. 6, the filtered result being smaller than the threshold occurs before the preamble symbol ends (the determination result of step S1020 is affirmative), and the determining circuit 920 at this point sets a left edge indicator of the frequency notch according to the subcarrier bin index (step S1030). More specifically, for FIG. 4 to FIG. 6, the determining circuit 920 sets the left edge indicator of the frequency notch according to the subcarrier bin index B1, and stores the left edge indicator of the frequency notch to the storage circuit 930.

The counter 910 continues determining which of the end of the preamble symbol and the filtered result being greater than or equal to the threshold occurs first (steps S1035 and S1040). For FIG. 4 and FIG. 5, if the filtered result becomes greater than or equal to the threshold (occurring at the subcarrier bin index B2) before the preamble symbol ends (the determination result of step S1040 is affirmative), the determining circuit 920 controls the counter 910 to start counting (step S1045). Each time a new filtered result enters the detector 740, the counter 910 adds the counter value by 1. Next, the determining circuit 920 determines which of the counter value reaching a predetermined value (the counter 910 generates a control signal to notify the determining circuit 920) and the filtered result being smaller than the threshold occurs first (steps S1050 and S1055). For the situation in FIG. 4, the determination result of step S1050 is affirmative first, and so the determining circuit 920 sets a right edge indicator of the frequency notch according to the subcarrier bin index (step S1060) and stores the right edge indicator of the frequency notch to the storage circuit 930. For the situation in FIG. 5, the determination result of step S1055 is affirmative first (i.e., B4-B2 is smaller than the predetermined value), and so the determining circuit 920 controls the counter 910 to stop counting, and resets the counter value (step S1065). With the counting of the counter 910, the detector 740 may eliminate the noise signal in FIG. 5 to prevent misjudgment. After step S1060 is completed, the determining circuit 920 returns to step S1020 to continue determining whether there are other frequency notches. In continuation of the example in FIG. 4, the determining circuit 920 sets a left edge indicator of another frequency notch and a right edge indicator of the another frequency notch according to the subcarrier bin indices B3 and B4 in step S1030 and step S1060, and stores the left edge indicator and the right edge indicator of the another frequency notch to the storage circuit 930. On the other hand, after step S1065 is completed, the determining circuit 920 returns to step S1035 to continue determining whether the end of the preamble symbol is reached. In continuation of the example in FIG. 5, the determining circuit 920 sets the right edge indicator of the frequency notch according to the subcarrier bin index B5 in step S1060, and stores the right edge indicator of the frequency notch to the storage circuit 930.

In the examples in FIG. 4 and FIG. 5, it is determined that the end of the preamble symbol is reached in step S1025. At this point, the determining circuit 920 sets the right edge indicator of the preamble symbol as a maximum value of the subcarrier bin index (step S1070), generates the frequency notch detection result according to the register value of the storage circuit S930 (step S1075), and continues determining a next preamble symbol (step S1005). More specifically, in step S1075, the determining circuit 920 determines the width of the preamble symbol, the width of the frequency notch and the number of the frequency notch according to the value and the number of the left edge indicator of the frequency notch, the value and the number of the right edge indicator of the frequency notch, the left edge indicator of the preamble symbol and the right edge indicator of the preamble symbol, and accordingly generates the frequency notch detection result.

For the situation in FIG. 6, the determining circuit 920 performs steps S1020, S1030, S1035 and S1040, and enters step S1080 when the determination result of step S1035 is affirmative. More specifically, as the frequency notch exists at the end of the preamble symbol, the right edge of the preamble symbol is substantially only near the subcarrier bin index B1. Thus, in step S1080, the determining circuit 920 sets the right edge indicator of the preamble symbol according to the left edge indicator of the previous frequency notch (set according to the subcarrier bin index B1 in step S1030), and stores the right edge indicator of the preamble symbol to the storage circuit 930. Next, step S1075 is similarly performed, and the frequency notch detection result is generated according to the register value.

It should be noted that, in the embodiments above, the preamble data is first filtered by the filtering circuit 730 before entering the detector 740. Therefore, to obtain more accurate subcarrier bin indices, the detector 740 may (1) consider the delay caused by the filtering circuit 730 in steps S1015, S1030 and S1060; or (2) consider the delay caused by the filtering circuit 730 in step S1075. In other embodiments, if the basis that the detector 740 uses for determination is unfiltered preamble data, the above correction process need not be conducted.

One person skilled in the art may understand implementation details and variations of the method in FIG. 3, FIG. 8 and FIG. 10 based on the disclosure of the device in FIG. 2, FIG. 7 and FIG. 9. While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A signal processing device of a television receiving end, the television receiving end comprising a tuner that receives a television signal, the television signal comprising preamble data, the signal processing device comprising:
an analog-to-digital converter (ADC), converting the television signal from an analog format to a digital format;
a fast Fourier transform (FFT) circuit, transforming the television signal in the digital format to a frequency-domain television signal;
a preamble data detecting circuit, detecting the preamble data in the frequency-domain television signal to generate a preamble data detection result;
a frequency notch detecting circuit, detecting a frequency notch of the preamble data in the frequency-domain television signal according to the preamble data detection result to generate a frequency notch detection result; and
a decoder, decoding the frequency-domain television signal to generate decoded data;
wherein, the frequency notch detection result is for the tuner to accordingly to determine whether to change a receiving frequency band.

2. The signal processing device according to claim 1, wherein the decoder performs decoding when the frequency notch detection result indicating that the frequency notch does not exist.

3. The signal processing device according to claim 1, wherein the preamble data comprises a plurality of subcarriers, and the frequency notch detecting circuit comprises:
a first calculating circuit, calculating magnitudes of the subcarriers to generate a plurality of calculation results;
a storage circuit, buffering the calculation results;
a second calculating circuit, generating a threshold according to the buffered calculation results;
a filtering circuit, generating a plurality of filtered results according to the buffered calculation results; and
a detector, generating the frequency notch detection result according to the filtered results and the threshold.

4. The signal processing device according to claim 3, wherein the calculation results are respectively the magnitudes of the subcarriers, and the first calculating circuit replaces a first calculation result among the calculation results by a first predetermined value when the first calculation result is greater than the first predetermined value.

5. The signal processing device according to claim 3, wherein the calculation results are respectively the magnitudes of the subcarriers, and the threshold is a product of a maximum of the calculation results and a second predetermined value.

6. The signal processing device according to claim 3, wherein the television signal is an orthogonal frequency-division multiplexing (OFDM) signal, the subcarriers are in form of complex numbers, and the calculation results are respectively the magnitudes of the subcarriers.

7. The signal processing device according to claim 3, wherein the detector comprises:
a determining circuit, comparing the filtered results with the threshold to generate the frequency notch detection result;
wherein, when a width of the frequency notch is greater than a predetermined value, the tuner changes the receiving frequency band according to the frequency notch detection result.

8. The signal processing device according to claim 3, wherein the detector comprises:
a determining circuit, comparing the filtered results with the threshold to generate the frequency notch detection result;
wherein, when the number of the frequency notch is greater than a predetermined value, the tuner changes the receiving frequency band according to the frequency notch detection result.

9. The signal processing device according to claim 3, wherein the filtering circuit is a moving average calculating circuit.

10. The signal processing device according to claim 1, the television signal further comprising body data, the signal processing device further comprising:
a frequency-domain synchronization circuit, coupled to the FFT circuit, performing synchronization on the preamble data and the body data of the frequency-domain television signal.

11. A signal processing method of a television receiving end, the television receiving end comprising a tuner that receives a television signal, the television signal comprising preamble data, the signal processing method comprising:
converting the television signal from an analog format to a digital format;
transforming the television signal in the digital format to a frequency-domain television signal;
detecting the preamble data in the frequency-domain television signal to generate a preamble data detection result;
detecting a frequency notch of the preamble data in the frequency-domain television signal according to the preamble data detection result to generate a frequency notch detection result; and
decoding the frequency-domain television signal to generate decoded data;
wherein, the frequency notch detection result is for the tuner to accordingly to determine whether to change a receiving frequency band.

12. The signal processing method according to claim 11, wherein the step of decoding the frequency-domain television signal to generate the decoded data is performed when the frequency notch detection result indicating that the frequency notch does not exist.

13. The signal processing method according to claim 11, wherein the preamble data comprises a plurality of subcarriers, and the step of detecting the frequency notch of the preamble data in the frequency-domain television signal according to the preamble data detection result to generate the frequency notch detection result comprises:
calculating magnitudes of the subcarriers to generate a plurality of calculation results;
buffering the calculation results;
generating a threshold according to the buffered calculation results;
generating a plurality of filtered results according to the buffered calculation results; and
generating the frequency notch detection result according to the filtered results and the threshold.

14. The signal processing method according to claim 13, wherein the calculation results are respectively the magnitudes of the subcarriers, and the step of generating the calculation results according to the subcarriers replaces a first calculation result among the calculation results by a first predetermined value when the first calculation result is greater than the first predetermined value.

15. The signal processing method according to claim 13, wherein the calculation results are respectively the magnitudes of the subcarriers, and the threshold is a product of a maximum of the calculation results and a second predetermined value.

16. The signal processing method according to claim 13, wherein the television signal is an orthogonal frequency-division multiplexing (OFDM) signal, the subcarriers are in form of complex numbers, and the calculation results are respectively the magnitudes of the subcarriers.

17. The signal processing method according to claim 13, wherein the step of generating the frequency notch detection result according to the filtered results and the threshold comprises:
comparing the filtered results with the threshold to generate the frequency notch detection result;
wherein, when a width of the frequency notch is greater than a predetermined value, the tuner changes the receiving frequency band according to the frequency notch detection result.

18. The signal processing method according to claim 13, wherein the step of generating the frequency notch detection result according to the filtered results and the threshold comprises:
comparing the filtered results with the threshold to generate the frequency notch detection result;
wherein, when the number of the frequency notch is greater than a predetermined value, the tuner changes the receiving frequency band according to the frequency notch detection result.

19. The signal processing method according to claim 13, wherein the step of generating the filtered results according to the buffered calculation results is performed by a moving average calculating method.

20. The signal processing method according to claim 11, the television signal further comprising body data, the method further comprising:
performing synchronization on the preamble data and the body data of the frequency-domain television signal.
